(19) United States
(12) Patent Application Publication
(10) Pub. No.: US 2022/0318719 A1
(43) Pub. Date: Oct. 6, 2022

(54) VEHICLE ALLOCATION FOR FIXED RENTAL RIDES

(71) Applicant: ANI TECHNOLOGIES PRIVATE LIMITED, Bengaluru (IN)

(72) Inventors: Bhavneet Singh Dhingra, Bangalore (IN); Ranjeet Ranjan, Bangalore (IN)

(73) Assignee: ANI TECHNOLOGIES PRIVATE LIMITED, Bengaluru (IN)

(21) Appl. No.: 17/413,085

(22) PCT Filed: Dec. 11, 2019
(86) PCT No.: PCT/IN2019/050908

§ 371 Date: Jun. 11, 2021

(30) Foreign Application Priority Data
Dec. 12, 2018 (IN) 201841047099

(51) Int. Cl. G06Q 10/06; G06Q 30/06; G06Q 50/30

(52) U.S. Cl. CPC G06Q 10/063112; G06Q 30/0645; G06Q 50/30

(57) ABSTRACT

Vehicle allocation methods for rental rides are provided. An online booking request for a rental ride is initiated by a passenger. Further, an available driver is identified from a set of available drivers based on one or more factors, such as a logged-in time duration of each available driver, a ride-time duration associated with the rental ride, a probability of extending the rental ride by the passenger, a destination location of each available driver, a probability of cancelling the booking request by the passenger, a current location of each available driver, a pick-up location of the passenger, a traffic stopover duration of each available driver, a number of cancelled booking requests associated with each available driver, or a driver category associated with each available driver. Thereafter, a vehicle associated with the identified driver is allocated to the passenger for the rental ride.

### CROSS-RELATED APPLICATIONS

This application claims priority of WIPO Application Serial No. PCT/IN2019/050908 filed Dec. 11, 2019, which claims priority of Indian Application Serial No. 201841047099, filed Dec. 12, 2018, the contents of which are incorporated herein by reference.

### FIELD OF THE INVENTION

Various embodiments of the disclosure relate generally to vehicle allocation systems. More specifically, various embodiments of the disclosure relate to allocation of vehicles for fixed rental rides.

### BACKGROUND

In recent years, the popularity for on-demand vehicle services has increased tremendously as these services can be offered quickly and conveniently to passengers. Cab service providers offer a wide range of ride services, such as point-to-point rides, shared rides, and outstation rides, to the passengers. In addition, the cab service providers also offer fixed rental rides to the passengers where the passengers have an option to rent vehicles for a fixed time duration or a fixed ride distance.

Generally, a booking request for a fixed rental ride is initiated by a passenger by utilizing a website or a mobile application facilitated by a cab service provider. For booking the fixed rental ride, a pick-up location and a pick-up time for the fixed rental ride are specified by the passenger. The passenger may additionally specify the fixed time duration or the fixed ride distance for the fixed rental ride while initiating the booking request. The passenger does not specify a drop-off location for the fixed rental ride.

Generally, the cab service provider allocates drivers from a pool of drivers (associated with the cab service provider) to the passengers for offering various types of vehicle services. For example, based on the booking request for the fixed rental ride initiated by the passenger, the cab service provider allocates a vehicle and an associated driver to the passenger for the fixed rental ride based on an acceptance of the rental request by the driver.

However, in certain scenarios, the driver may not make an acceptance decision accurately because of various reasons. In one example, the driver may get a rental ride after being on the duty all day long. In another example, the passenger tends to extend the rental ride. In another example, the driver does not know the direction in which the passenger wants to travel, which may be in the opposite direction to the driver's home location. In another example, the driver may get the rental ride in which the pick-up location is far away from the driver's current location. In another example, the driver accepts the rental request and is travelling towards the passenger's pick-up location, but the passenger cancels the rental request. During allocations of the vehicles for the fixed rental rides, the above-mentioned reasons are currently not being considered, which may cause personal as well as profession inconveniences to drivers.

In light of the foregoing, there exists a need for a technical and more reliable solution that solves the above-mentioned problems and manages allocation of vehicles to passengers for fixed rental rides.

### SUMMARY

An embodiment of the present disclosure provides vehicle allocation method and system for allocating vehicles to passengers for fixed rental rides. The vehicle allocation method includes one or more operations that are executed by circuitry of a transportation server to allocate the vehicles to the passengers for the fixed rental rides. The circuitry receives a booking request for a fixed rental ride from a passenger device of a passenger. The booking request includes at least a ride-time duration for the fixed rental ride. The circuitry identifies a subset of drivers from a set of ranked drivers based on a logged-in time duration of each driver and the ride-time duration. In one example, the subset of drivers may include one or more drivers who are selected from the set of ranked drivers such that a sum of the logged-in time duration of each driver in the subset of drivers and the ride-time duration is less than or equal to a first time duration. In another example, the subset of drivers may include one or more drivers selected from the set of ranked drivers such that a sum of the logged-in time duration of each driver in the subset of drivers and the ride-time duration is greater than the first time duration.

Further, the circuitry identifies a first driver from the subset of drivers based on the logged-in time duration of each driver in the subset of drivers and at least one of the ride-time duration, a probability of extending the fixed rental ride by the passenger, or a destination location of each driver in the subset of drivers. In one example, the first driver may be identified from the subset of drivers when the logged-in time duration of the first driver is less than logged-in time durations of remaining drivers in the subset of drivers and the ride-time duration is greater than a second time duration. In another example, the first driver may be identified from the subset of drivers when the logged-in time duration of the first driver is less than the logged-in time durations of the remaining drivers in the subset of drivers and the probability of extending the fixed rental ride is greater than a threshold value. In another example, the first driver may be identified from the subset of drivers when the logged-in time duration of the first driver is greater than the logged-in time durations of the remaining drivers in the subset of drivers and the destination location of the first driver is within a defined radial distance of a drop-off location associated with the fixed rental ride. Upon identification of the first driver, the circuitry allocates a first vehicle associated with the first driver to the passenger for the fixed rental ride.

Another embodiment of the present disclosure provides vehicles allocation method and system for allocating vehicles to passengers for fixed rental rides. The vehicle allocation method includes one or more operations that are executed by circuitry of a transportation server to allocate the vehicles to the passengers for the fixed rental rides. The circuitry receives a booking request for a fixed rental ride from a passenger device of a passenger. The booking request includes at least a pick-up location of the passenger. The circuitry further retrieves historical rental data of the passenger from a storage server, and predicts a probability of cancelling the booking request by the passenger based on the historical rental data. When the probability of cancelling the booking request by the passenger is greater than a threshold value, the circuitry identifies a first driver from a set of ranked drivers based on a current location of each driver in the set of ranked drivers and the pick-up location of the passenger. In one example, the first driver may be identified from the set of ranked drivers when the distance between the first driver and the passenger is less than the distance between each of remaining drivers in the set of ranked drivers and the passenger. In another example, the first driver may be identified from the set of ranked drivers when the distance between the first driver and the passenger is less than the distance between each of the remaining drivers and the passenger, and the number of cancelled booking requests associated with the first driver is less in comparison to the remaining drivers. Upon identification of the first driver, the circuitry allocates a first vehicle associated with the first driver to the passenger for the fixed rental ride.

Another embodiment of the present disclosure provides vehicles allocation method and system for allocating vehicles to passengers for fixed rental rides. The vehicle allocation method includes one or more operations that are executed by circuitry of a transportation server to allocate the vehicles to the passengers for the fixed rental rides. The circuitry receives a booking request for a fixed rental ride from a passenger device of a passenger. The circuitry determines a traffic stopover duration of each driver in a set of available drivers based on real-time driving information of each driver. The real-time driving information includes at least driving pattern information and a number of cancelled booking requests associated with each driver. Drivers in the set of available drivers are ranked based on the traffic stopover duration of each driver to generate a set of ranked drivers.

The circuitry further identifies a first driver from the set of ranked drivers based on at least one of the traffic stopover duration, the number of cancelled booking requests, or a driver category associated with each of the set of ranked drivers. In one example, the first driver may be identified from the set of ranked drivers when the traffic stopover duration for the first driver is greater than traffic stopover durations for remaining drivers in the set of ranked drivers. In another example, the first driver may be identified from the set of ranked drivers when the number of cancelled booking requests for the first driver is greater than the number of cancelled booking requests for each of remaining drivers in the set of ranked drivers. Upon identification of the first driver, the circuitry allocates a first vehicle associated with the first driver to the passenger for the fixed rental ride.

Thus, methods and systems of the present disclosure provide a choice to a transport service provider (e.g., a cab service provider) to allocate a driver from a set of drivers to a passenger for a rental ride in an efficient and effective manner for optimizing utilization and earnings of the driver, thereby optimizing the association of the driver with the transport service provider.

### BRIEF DESCRIPTION OF DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates a system environment for vehicle allocation, in accordance with an exemplary embodiment of the disclosure;

FIG. 2 is a block diagram that illustrates a transportation server of the environment of FIG. 1, in accordance with an exemplary embodiment of the disclosure;

FIG. 3 is a vehicle allocation environment for allocating vehicles to passengers, in accordance with an exemplary embodiment of the disclosure;

FIG. 4 is a vehicle allocation environment for allocating vehicles to passengers, in accordance with another exemplary embodiment of the disclosure;

FIGS. 5A-5D, collectively, illustrates a flow chart of a method for allocating vehicles to passengers, in accordance with an exemplary embodiment of the disclosure;

FIG. 6 illustrates a flow chart of a method for allocating vehicles to passengers, in accordance with another exemplary embodiment of the disclosure;

FIG. 7 illustrates a flow chart of a method for allocating vehicles to passengers, in accordance with another exemplary embodiment of the disclosure; and

FIG. 8 is a block diagram that illustrates a computer system for allocating vehicles to passengers, in accordance with an exemplary embodiment of the disclosure.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present disclosure. There may be additional components described in the foregoing application that are not depicted on one of the described drawings. In the event such a component is described, but not depicted in a drawing, the absence of such a drawing should not be considered as an omission of such design from the specification.

Before describing the present disclosure in detail, it should be observed that the present disclosure utilizes a combination of system components, which constitutes a vehicle allocation system for fixed rental rides. Accordingly, the components and the method steps have been represented, showing only specific details that are pertinent for an understanding of the present disclosure so as not to obscure the disclosure with details that will be readily apparent to those with ordinary skill in the art having the benefit of the description herein. As required, detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Further, the terms and phrases used herein are not intended to be limiting but rather to provide an understandable description of the disclosure.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Terms Description (In Addition to Plain and Dictionary Meaning)

Vehicle is a means of transport that is deployed by a transport service provider, such as a cab service provider, to provide vehicle services to one or more passengers. For example, the vehicle is an automobile, a bus, a car, a bike, or the like. The one or more passengers may travel in the vehicle to commute between source and destination locations.

Passenger is an individual who wants to travel from one location to one or more other locations using a vehicle service offered by a transport service provider. For using the vehicle service, the passenger initiates a booking request for a ride with the transport service provider and provides ride details, such as a pick-up location, a drop-off location, a ride time duration, a ride distance, a vehicle type, a pick-up time, or a combination thereof.

Driver is an individual who drives a vehicle. The driver may register with a transport service provider (e.g., a cab service provider such as OLA) for offering on-demand vehicle services to one or more passengers in an online manner.

Rental ride is a type of ride that is associated with at least one of a fixed time duration or a fixed ride distance. By booking for the rental ride in an online manner, a passenger can get a vehicle at a preferred pick-up point and can travel to multiple locations within a geographical area, for example, a city or a town, with just one booking. The rental ride includes various ride packages on hourly basis (e.g., 1 hour, 2 hours, 3 hours, or the like), distance basis (e.g., 10 Kms, 20 Kms, 30 Kms, or the like), or a combination thereof. Hereinafter, the rental ride may be commonly referred to as a fixed rental ride.

Booking request is a request for a ride, for example, a rental ride, initiated by a passenger to travel from one location to one or more other locations. The booking request includes a pick-up location, a pick-up time, a vehicle type, a ride-time duration, a ride distance, or a combination thereof.

Ride-time duration is a time duration that is fixed for a rental ride. Hereinafter, the ride-time duration may be commonly referred to as a fixed ride-time duration or a fixed ride duration.

Ride distance is a distance that is fixed for a rental. Hereinafter, the ride distance may be commonly used as a fixed ride distance or a fixed distance for a ride.

Set of drivers is a group including one or more drivers who may be available for new allocations corresponding to one or more types of ride requests, for example, a point-to-point ride, a share ride, an outstation ride, a fixed rental ride, or the like. Hereinafter, the set of drivers may be commonly used as a set of available drivers.

Set of ranked drivers is a group including a set of available drivers who have been ranked based on one or more parameters. In one example, the set of available drivers may be ranked based on a logged-in time duration of each driver. In another example, the set of available drivers may be ranked based on a distance between a current location of each driver and a pick-up location of a passenger. In another example, the set of available drivers may be ranked based on a traffic stopover duration of each driver.

Logged-in time duration of a driver is a time duration since a log-in time of the driver with a service platform associated with a transport service provider, when the driver has not logged out of the service platform. Once the drive has logged out of the service platform, the drive is not considered for any new ride allocation.

Cancelled booking request is a booking request for a ride initiated by a passenger but was later cancelled by the passenger post allocation without availing the ride.

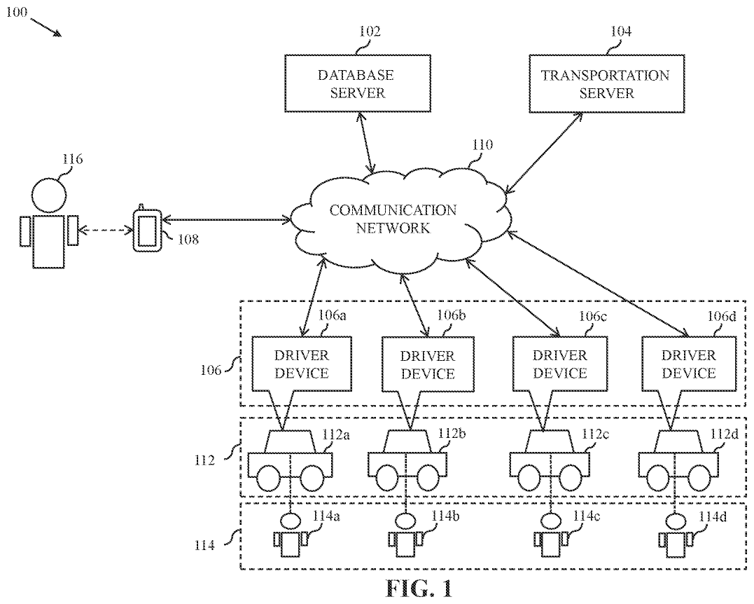

FIG. 1 is a block diagram that illustrates a system environment 100 for vehicle allocation, in accordance with an exemplary embodiment of the disclosure. The system environment 100 includes a database server 102, a transportation server 104, a set of driver devices 106 (such as driver devices 106a-106d), and a passenger device 108 that communicate with each other via a communication network 110. The set of driver devices 106 is associated with a set of vehicles 112 i.e., the driver devices 106a-106d are associated with vehicles 112a-112d, respectively. Similarly, the set of vehicles 112 is associated with a set of available drivers 114 i.e., the vehicles 112a-112d are associated with drivers 114a-114d, respectively. The passenger device 108 is associated with a passenger 116. Further, the set of vehicles 112 may be digitally connected with a ride-hailing platform (hosted by the transportation server 104) for offering various types of ride services to one or more passengers such as the passenger 116.

The database server 102 may include suitable logic, circuitry, interfaces, and/or code, executable by the circuitry, that may be configured to perform one or more database operations, such as receiving, storing, processing, and transmitting queries, data, or content, such as passenger data, driver data, vehicle data, booking data, allocation data, or the like. The database server 102 may be a data management and storage server that performs the one or more database operations. The queries, data, or content may be received/transmitted from/to various components of the system environment 100, such as the transportation server 104, the driver devices 106a-106d, or the passenger device 108. In an exemplary embodiment, the database server 102 may be configured to manage and store historical travel data of the one or more passengers, such as the passenger 116, who may have availed the vehicles services in the past. The historical travel data of the passenger 116 may include historical rental data of the passenger 116. The historical rental data may include ride information such as a number of booking requests initiated by the passenger 116 for fixed rental rides (hereinafter, “rental rides”) and a number of rental rides availed by the passenger 116 in the past. The historical rental data may further include a number of booking requests cancelled by the passenger 116 in the past. The historical rental data may further include a number of rental rides extended by the passenger 116 beyond a fixed ride-time duration (hereinafter, “ride-time duration”) and/or a fixed ride distance (hereinafter, “ride distance”) associated with a corresponding rental ride. The historical rental data may further include pick-up and drop-off locations associated with each corresponding rental ride availed by the passenger 116 in the past. In one example, the pick-up and drop-off locations may be represented by latitude and longitude coordinates. The historical rental data may further include a time stamp indicating at least a time of initiating each booking request by the passenger 116. Along with the historical travel data of each passenger (such as the passenger 116), the database server 102 may be configured to manage and store passenger information of the passenger 116. The passenger information may include at least a passenger name, a passenger identifier (ID), and a passenger contact number, along with other information pertaining to a passenger account of each passenger registered with a vehicle service provider.

The database server 102 may be further configured to manage and store driver information of one or more drivers such as the drivers 114a-114d. The driver information of each driver may include at least a driver name, a driver contact number, a driver home location, a driver license ID, and a driver registration ID, along with other information pertaining to a driver account of each driver registered with the vehicle service provider such as OLA. The driver information may further include preferences, ratings, feedback, working hours (or duty hours), and historical driving experiences of each driver. The database server 102 may be further configured to manage and store vehicle information of one or more vehicles such as the vehicles 112a-112d associated with the drivers 114a-114d, respectively. The vehicle information of each vehicle may include a vehicle type, a vehicle capacity, a vehicle number, a vehicle registration ID, a vehicle chassis number, or other vehicle-related information.

The database server 102 may be further configured to manage and store real-time driving information of each driver. The real-time driving information may include a logged-in time, a logged-out time, a current location, and a number of cancelled booking requests associated with each driver. The real-time driving information may further include driving pattern information of each driver that indicates driving behavior of each driver while driving a corresponding vehicle. The driving pattern information may be generated based on at least one of vehicle spatial-temporal location information, vehicle dynamics information including speed, acceleration, and deceleration, feedback, or the like.

In an embodiment, the database server 102 may be configured to receive one or more queries from the transportation server 104 via the communication network 110. The one or more queries may indicate one or more requests for retrieving requisite information (such as the historical rental data, the vehicle information, the driver information, the passenger information, the real-time driving information, or any combination thereof). In response to the received query, the database server 102 may be configured to retrieve and transmit the requested information to the transportation server 104 via the communication network 110. Examples of the database server 102 include, but are not limited to, a personal computer, a laptop, or a network of computer systems.

The transportation server 104 may include suitable logic, circuitry, interfaces, and/or code, executable by the circuitry, that may be configured to perform one or more operations for vehicle allocation. The transportation server 104 may be a computing device, which may include a software framework, that may be configured to create the transportation server implementation and perform the various operations associated with the vehicle allocation. The transportation server 104 may be realized through various web-based technologies, such as, but not limited to, a Java web-framework, a .NET framework, a PHP framework, a python framework, or any other web-application framework. Examples of the transportation server 104 include, but are not limited to, a personal computer, a laptop, or a network of computer systems.

In an embodiment, the transportation server 104 may be configured to receive a booking request (i.e., an online booking request) for a rental ride from the passenger device 108 via the communication network 110. The booking request may include at least one of a ride-time duration or a ride distance for the rental ride requested by the passenger 116. The booking request may further include a pick-up location, a pick-up time, or a vehicle type specified by the passenger 116 for the rental ride.

In an embodiment, the transportation server 104 may be configured to determine a rental ride fare for the rental ride based on at least the booking request. The transportation server 104 may be further configured to render a booking interface (e.g., a graphical user interface “GUI”) on the passenger device 108 for presenting at least the rental ride fare to the passenger 116. The transportation server 104 may be further configured to receive a confirmation message from the passenger device 108 via the communication network 110. The confirmation message may indicate confirmation of the rental ride, by the passenger 116, based on at least the rental ride fare. Based on the confirmation, the transportation server 104 may be further configured to initiate an allocation process for allocating an available vehicle to the passenger 116 for the rental ride.

In one embodiment of the allocation process, the transportation server 104 may be configured to identify a subset of drivers from a first set of ranked drivers based on at least a logged-in time duration of each driver, the ride-time duration, a first time duration, or a combination thereof. The first set of ranked drivers may be obtained by ranking drivers from the set of available drivers 114 based on the logged-in time duration of each driver in the set of available drivers 114. Upon identification of the subset of drivers, the transportation server 104 may be configured to identify a driver (e.g., a first driver 114a) from the subset of drivers based on the logged-in time duration of each of the subset of drivers and at least one of the ride-time duration, a probability of extending the rental ride by the passenger 116, or a destination location (e.g., a home location) of each of the subset of drivers. The transportation server 104 may be further configured to allocate a first vehicle 112a associated with the first driver 114a to the passenger 116 for the rental ride. Based on the allocation, the first driver 114a may pick the passenger 116 from the passenger's pick-up location and transport the passenger 116 to one or more desired drop-off locations of the passenger 116. The first driver 114a may access a digital map (hosted by the transportation server 104) to navigate between a plurality of locations. For example, the digital map may be utilized, by the first driver 114a, to reach the passenger's pick-up location from a current location of the first driver 114a. Similarly, the digital map may be utilized, by the first driver 114a, to navigate between the passenger's pick-up location and a desired drop-off location specified by the passenger 116.

In another embodiment of the allocation process, the transportation server 104 may be configured to retrieve the historical rental data of the passenger 116 from a storage server such as the database server 102. Further, based on the historical rental data, the transportation server 104 may be configured to predict a probability of cancelling the booking request by the passenger 116. The transportation server 104 may be further configured to identify a driver (e.g., a second driver 114b) from a second set of ranked drivers based on a current location of each driver in the second set of ranked drivers and the pick-up location of the passenger 116, when the probability of cancelling the booking request is greater than a threshold value. The second set of ranked drivers may be obtained by ranking drivers from the set of available drivers 114 based on a distance between the current location of each driver in the set of available drivers 114 and the pick-up location of the passenger 116. The transportation server 104 may be further configured to allocate a second vehicle 112b associated with the second driver 114b to the passenger 116 for the rental ride. Based on the allocation, the second driver 114b may pick the passenger 116 from the passenger's pick-up location and transport the passenger 116 to one or more desired drop-off locations of the passenger 116. The second driver 114b may access a digital map (hosted by the transportation server 104) to navigate between a plurality of locations. For example, the digital map may be utilized, by the second driver 114b, to reach the passenger's pick-up location from a current location of the second driver 114b. Similarly, the digital map may be utilized, by the second driver 114b, to navigate between the passenger's pick-up location and a desired drop-off location specified by the passenger 116.

In another embodiment of the allocation process, the transportation server 104 may be configured to determine a traffic stopover duration of each driver in the set of available drivers 114 based on the real-time driving information of each driver. Further, a third set of ranked drivers may be obtained by ranking drivers from the set of available drivers 114 based on the traffic stopover duration of each driver in the set of available drivers 114. The transportation server 104 may be further configured to identify a driver (e.g., a third driver 114c) from the third set of ranked drivers based on at least one of the traffic stopover duration, the number of cancelled booking requests, or a driver category associated with each of the third set of ranked drivers. The transportation server 104 may be further configured to allocate a third vehicle 112c associated with the third driver 114c to the passenger 116 for the rental ride. Based on the allocation, the third driver 114c may pick the passenger 116 from the passenger's pick-up location and transport the passenger 116 to one or more desired drop-off locations of the passenger 116. The third driver 114c may access a digital map (hosted by the transportation server 104) to navigate between a plurality of locations. For example, the digital map may be utilized, by the third driver 114c, to reach the passenger's pick-up location from a current location of the third driver 114c. Similarly, the digital map may be utilized, by the third driver 114c, to navigate between the passenger's pick-up location and a desired drop-off location specified by the passenger 116.

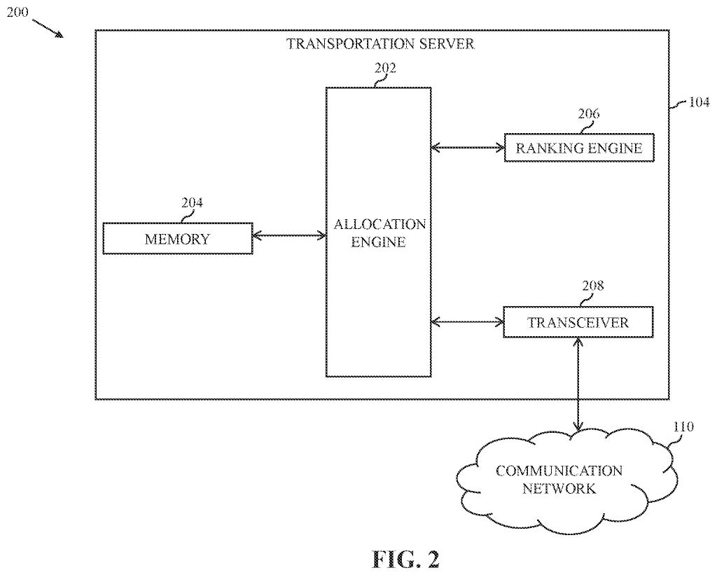

Upon allocation of the available vehicle (e.g., the first vehicle 112a, the second vehicle 112b, or the third vehicle 112c) to the passenger 116, the transportation server 104 may be further configured to generate and transmit allocation information to a corresponding driver device (e.g., a first driver device 106a, a second driver device 106b, or a third driver device 106c) and/or the passenger device 108. The allocation information may include at least one of the passenger, driver, or rental ride information. Various operations of the transportation server 104 have been described in detail in conjunction with FIGS. 2-4, 5A-5D, 6, and 7.

It will be apparent to a person having ordinary skill in the art that the scope of the disclosure is not limited to implementation of the database server 102 and the transportation server 104 as separate entities. In an embodiment, the functionalities of the database server 102 may be integrated into the transportation server 104 or vice-versa, without departing from the scope of the disclosure. Further, in an embodiment, the transportation server 104 may be realized as an application program installed on and/or running on each of the set of driver devices 106 and/or the passenger device 108, without departing from the scope of the disclosure.

The set of driver devices 106, for example, the first driver device 106a may include suitable logic, circuitry, interfaces, and/or code, executable by the circuitry, that may be configured to perform one or more operations associated with various types of ride services. The first driver device 106a may be a computing device that is utilized by the first driver 114a of the first vehicle 112a to perform the one or more operations. For example, the first driver device 106a may be utilized, by the first driver 114a, to input or update the driver or vehicle information by means of a service application that runs on the first driver device 106a. The first driver device 106a may be further utilized, by the first driver 114a, to login or logout of the ride-hailing platform associated with the vehicle service provider. The first driver device 106a may be further utilized, by the first driver 114a, to input one or more preferences for working hours, ride types, feedback, or the like. The first driver device 106a may be further utilized, by the first driver 114a, to navigate between the plurality of locations by means of the digital map hosted by the transportation server 104. The first driver device 106a may be further utilized, by the first driver 114a, to view the booking request communicated by the transportation server 104. The first driver device 106a may be further utilized, by the first driver 114a, to accept or reject the booking request. The first driver device 106a may be further utilized, by the first driver 114a, to view the passenger information and direction between the plurality of locations based on allocation of the first vehicle 112a to the passenger 116.

In an embodiment, the first driver device 106a may be configured to transmit log-in information, such as a logged-in time or a logged-out time, of the first driver 114a to the transportation server 104 via the communication network 110. The first driver device 106a may be further configured to periodically transmit real-time booking status and real-time position information to the transportation server 104 via the communication network 110. The real-time booking status may indicate an availability status of the first vehicle 112a (i.e., whether the first vehicle 112a is currently occupied or is available for a new booking request). The real-time position information may indicate current position information (e.g., spatial-temporal location information) of the first driver device 106a, which in turn may indicate the current position information (e.g., spatial-temporal location information) of the first vehicle 112a. The first driver device 106a may include one or more position-tracking sensors (not shown) for tracking the real-time position information by way of a navigation system such as a global positioning system (GPS).

In an embodiment, the first driver device 106a may be further configured to detect the vehicle dynamics information, such as speed, acceleration, deceleration, or the like, of the first vehicle 112a and transmit the vehicle dynamics information to the transportation server 104. In another embodiment, the first driver device 106a may communicate with a vehicle device (not shown) or an on-board diagnostic device (not shown) of the first vehicle 112a for receiving the vehicle dynamics information, and then transmit the vehicle dynamics information to the transportation server 104. In an exemplary embodiment, the first driver device 106a may be a vehicle head unit. In another exemplary embodiment, the first driver device 106a may be a communication device, such as a smartphone, a tablet, or any other portable communication, that is placed inside the first vehicle 112a. Various operations and functionalities of other driver devices, such as the second, third, or fourth driver device 106b, 106c, or 106d, may be similar to the first driver device 106a, as described above.

The passenger device 108 may include suitable logic, circuitry, interfaces, and/or code, executable by the circuitry, that may be configured to perform one or more operations for vehicle booking. The passenger device 108 may be a computing device that is utilized, by the passenger 116, to initiate the one or more operations by means of a service application (associated with the vehicle service provider and hosted by the transportation server 104) running on the passenger device 108. For example, the passenger device 108 may be utilized, by the passenger 116, to initiate the booking request (i.e., the online booking request) for the rental ride. To schedule the rental ride, the passenger device 108 may be utilized, by the passenger 116, to input ride details of the booking request, such as the pick-up location, the pick-up time, the vehicle type, the ride-time duration, the ride distance, or a combination thereof, by way of a booking interface rendered by the service application (or the transportation server 104) on the passenger device 108. In a scenario where the pick-up location is same as a current location of the passenger 116, the service application running on the passenger device 108 may be configured to automatically detect and present the pick-up location to the passenger 116. In another scenario where the pick-up location is not same as the current location of the passenger 116, the passenger device 108 may be utilized, by the passenger 116, to input the pick-up location.

In an embodiment, the passenger device 108 (or the service application running on the passenger device 108) may be configured to transmit the booking request to the transportation server 104 and receive ride fare and ride information from the transportation server 104 via the communication network 110. The booking interface may present the rental ride fare to the passenger 116. The booking interface may further include one or more selectable options (e.g., 2-dimensional or 3-dimensional user interface buttons or tabs) that may be selected, by the passenger 116, to confirm or reject the booking request based on at least the rental ride fare. The passenger device 108 may be further configured to receive the allocation information from the transportation server 104. Upon completion of the rental ride, the passenger device 108 may be utilized, by the passenger 116, to initiate an electronic transaction request to make an online payment corresponding to the rental ride fare associated with the rental ride. The passenger device 108 may be configured to transmit the electronic transaction request to the transportation server 104 based on an online payment mode selected by the passenger 116. Examples of the passenger device 108 include, but are not limited to, a personal computer, a laptop, a smartphone, and a tablet computer.

The communication network 110 may include suitable logic, circuitry, interfaces, and/or code, executable by the circuitry, that may be configured to transmit queries, messages, and requests between various entities, such as the database server 102, the transportation server 104, the set of driver devices 106, and/or the passenger device 108. Examples of the communication network 110 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the system environment 100 may connect to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a block diagram 200 that illustrates the transportation server 104, in accordance with an exemplary embodiment of the disclosure. The transportation server 104 includes the circuitry such as an allocation engine 202, a memory 204, a ranking engine 206, and a transceiver 208.

The allocation engine 202 may include suitable logic, circuitry, interfaces, and/or codes, executable by the circuitry, that may be configured to perform one or more vehicle allocation operations. For example, the allocation engine 202 may be configured to receive the booking request for the rental ride from the passenger device 108 and initiate the allocation process for allocating the available vehicle to the passenger 116 for the rental ride. In an embodiment, the allocation engine 202 may be configured to determine and store the logged-in time duration of each driver, the distance between the current location of each driver and the passenger 116, the traffic stopover duration of each driver, or the like, in the memory 204. The allocation engine 202 may further communicate one or more instructions and control commands to other circuitry of the transportation server 104, such as the memory 204, the ranking engine 206, or the transceiver 208, for performing their respective operations. Examples of the allocation engine 202 include, but are not limited to, an application-specific integrated circuit (ASIC) processor, a reduced instruction set computing (RISC) processor, a complex instruction set computing (CISC) processor, or a field-programmable gate array (FPGA). It will be apparent to a person skilled in the art that the allocation engine 202 may be compatible with multiple operating systems.

The memory 204 may include suitable logic, circuitry, interfaces, and/or codes, executable by the circuitry, that may be configured to store one or more instructions or codes that are executed by the allocation engine 202, the ranking engine 206, or the transceiver 208 to perform their respective operations, either independently or in conjunction with each other. In an embodiment, the memory 204 may be further configured to store the booking request received from the passenger device 108. The memory 204 may further store the passenger information (e.g., the historical rental data) of the passenger 116, the driver information (e.g., the availability status, the logged-in time duration, the home location, or the like) of each driver, or the vehicle information of each vehicle. The memory 204 may further store ranking information indicating ranking of the drivers in the set of available drivers 114. The memory 204 may further store the allocation information based on allocation of each available driver (and the associated vehicle) to each passenger. Examples of the memory 204 include, but are not limited to, a random-access memory (RAM), a read-only memory (ROM), a programmable ROM (PROM), and an erasable PROM (EPROM).

The ranking engine 206 may include suitable logic, circuitry, interfaces, and/or codes, executable by the circuitry, that may be configured to execute one or more ranking operations. For example, the ranking engine 206 may be configured to rank the drivers in the set of available drivers 114. In one embodiment, the ranking engine 206 may rank the available drivers in the set of available drivers 114 based on the logged-in time duration of each available driver and generate ranking information including the first set of ranked drivers. In another embodiment, the ranking engine 206 may rank the available drivers based on the distance between the current location of each available driver and the pick-up location of the passenger 116 and generate ranking information including the second set of ranked drivers. In another embodiment, the ranking engine 206 may rank the available drivers based on the traffic stopover duration of each available driver and generate ranking information including the third set of ranked drivers. Upon generation of the ranking information, the ranking engine 206 may store the ranking information in the memory 204. The ranking engine 206 may be implemented by one or more processors, such as, but are not limited to, an ASIC processor, a RISC processor, a CISC processor, and an FPGA.

Although, the ranking engine 206 has been depicted as a separate entity in FIG. 2, a person skilled in the art will appreciate that the ranking engine 206 may be implemented within the allocation engine 202 without departing from the scope of the disclosure. In such a scenario, the allocation engine 202 may perform various operations and functionalities of the ranking engine 206, without departing from the scope of the disclosure.

The transceiver 208 may include suitable logic, circuitry, interfaces, and/or codes, executable by the circuitry, that may be configured to transmit (or receive) data to (or from) various servers or devices, such as the database server 102, the set of driver devices 106, or the passenger device 108. Examples of the transceiver 208 may include, but are not limited to, an antenna, a radio frequency transceiver, a wireless transceiver, and a Bluetooth transceiver. The transceiver 208 may be configured to communicate with the database server 102, the set of driver devices 106, or the passenger device 108 using various wired and wireless communication protocols, such as TCP/IP, UDP, LTE communication protocols, or any combination thereof.

In operation, the allocation engine 202 may be configured to receive the booking request for the rental ride from the passenger device 108. The allocation engine 202 may be further configured to process the booking request to determine booking information of the rental ride requested by the passenger 116 and store the booking information in the database server 102 or the memory 204. The booking information may include information associated with the rental ride, such as the pick-up location, the pick-up time, the ride-time duration, the ride distance, or a combination thereof, specified by the passenger 116.

In an embodiment, the allocation engine 202 may retrieve the historical rental data of the passenger 116 from the database server 102 and store the historical rental data in the memory 204. Based on the historical rental data of the passenger 116, the allocation engine 202 may be configured to predict the probability of extending the rental ride by the passenger 116. In an embodiment, the probability of extending the rental ride may be predicted based on the number of rental rides extended by the passenger 116 and the number of rental rides availed by the passenger 116 before initiating the current booking request for the rental ride. For example, the passenger 116 had availed “20 rental rides” in the past. Out of the “20 rental rides”, “12 rental rides” were extended by the passenger 116, either with respect to their respective ride-time durations, respective ride distances, or a combination thereof. Thus, for the passenger 116, the probability of extending the rental ride may be predicted as “0.6” (i.e.,“12” divided by “20”).

Further, the allocation engine 202 may be configured to predict the probability of cancelling the booking request by the passenger 116 based on the historical rental data of the passenger 116. In an embodiment, the probability of cancelling the booking request may be predicted based on the number of booking requests cancelled by the passenger 116 and the number of booking requests initiated by the passenger 116 for the rental rides, before initiating the current booking request for the rental ride. For example, the passenger 116 had initiated “30 rental rides” in the past. Out of the “30 rental rides”, “10 rental rides” were cancelled by the passenger 116 without availing the corresponding rental ride services. Thus, for the passenger 116, the probability of cancelling the booking request may be predicted as “0.33” (i.e., “10” divided by “30”). The allocation engine 202 may store the probabilities of extending the rental ride and cancelling the booking request by the passenger 116, as predicted above, in the database server 102 or the memory 204.

In an embodiment, the allocation engine 202 may be configured to processes real-time information (e.g., the real-time booking status and position information) of a pool of drivers associated with the vehicle service provider and select the set of available drivers 114 from the pool of drivers. The set of available drivers 114 may be selected based on at least one of the availability status of each driver, the position information of each driver, and the booking request initiated by the passenger 116. For example, if a driver from the pool of drivers is currently available for new allocation or may be available in a near future time (i.e., within a defined time period) and/or if the driver is within a defined radial distance of the passenger's pick-up location, then the driver may be identified as an available driver. For simplicity of discussion, the set of available drivers 114 has been described with four drivers such as first, second, third, and fourth drivers 114a, 114b, 114c, and 114d, as shown in FIG. 1.

In an embodiment, the allocation engine 202 may be configured to retrieve the requisite information, such as the driver information, the vehicle information, the real-time driving information, the log-in information, or the like, for each available driver in the set of available drivers 114 from the database server 102 and store the requisite information in the memory 204. The allocation engine 202 may be further configured to determine the logged-in time duration of each available driver. The logged-in time duration of each available driver may be determined based on at least the logged-in time of each available driver (who has not yet logged-out from the ride-hailing platform associated with the vehicle service provider). For example, the first driver 114a has logged-in at a time instance of “09:00:00 AM” and the current time instance is “12:00:00 PM”. Thus, for the first driver 114a, the logged-in time duration may be determined as “3 hours” (i.e., “09:00:00 AM” subtracted from “12:00:00 PM”). Similarly, the logged-in time duration of the second, third, and fourth drivers 114b, 114c, and 114d may be determined.

In an embodiment, the allocation engine 202 may be configured to determine the destination location (i.e., the home location) of each available driver based on the driver information of each available driver. The allocation engine 202 may be further configured to determine the current location of each available driver based on the real-time position information of each available driver. The allocation engine 202 may be further configured to determine the traffic stopover duration of each available driver based on the real-time driving information including at least the driving pattern information of each available driver. For example, based on the driving pattern information of the first driver 114a who has driven the first vehicle 112a from a first location (e.g., point-A) to a second location (e.g., point-B) in “30 minutes”, it is determined that the first vehicle 112a was not moving during various time durations such as “2 minutes”, “3 minutes”, and “4 minutes”. It is further determined that speed and acceleration associated with the first vehicle 112a were below defined speed and acceleration values (e.g., average speed and acceleration values of the first vehicle 112a) for “7 minutes”. In such a scenario, the traffic stopover duration for the first driver 114a may be determined as “16 minutes” (i.e., “2 minutes”+“3 minutes”+“4 minutes”+“7 minutes”). Similarly, the traffic stopover duration for the second, third, and fourth drivers 114b, 114c, and 114d may be determined. The allocation engine 202 may be configured to store the logged-in time duration, the destination location, the current location, and the traffic stopover duration of each driver in the memory 204.

In an embodiment, the allocation engine 202 may be configured to communicate a list of available drivers (i.e., the set of available drivers 114) to the ranking engine 206 for ranking the available drivers of the set of available drivers 114. The ranking engine 206 may be configured to rank the available drivers to obtain a set of ranked drivers. In one embodiment, the ranking engine 206 may rank the available drivers based on the logged-in time duration of each available driver and generate the ranking information including the first set of ranked drivers. The available drivers may be ranked in an ascending order or a descending order of their logged-in time durations. For example, the logged-in time durations of the first, second, third, and fourth drivers 114a, 114b, 114c, and 114d are “3 hours”, “2.5 hours”, “7 hours”, and “4 hours”, respectively. In one scenario where the available drivers are ranked in the ascending order of their logged-in time durations, the ranking engine 206 may obtain the first set of ranked drivers including the second driver 114b (“2.5 hours”), followed by the first driver 114a (“3 hours”), the fourth driver 114d (“4 hours”), and the third driver 114c (“7 hours”). In another scenario where the available drivers are ranked in the descending order of their logged-in time durations, the ranking engine 206 may obtain the first set of ranked drivers including the third driver 114c (“7 hours”), followed by the fourth driver 114d (“4 hours”), the first driver 114a (“3 hours”), and the second driver 114b (“2.5 hours”).

In another embodiment, the ranking engine 206 may rank the available drivers based on the distance between the current location of each available driver and the pick-up location of the passenger 116 and generate the ranking information including the second set of ranked drivers. The available drivers may be ranked in an ascending order or a descending order of their distances. For example, the distance between the current location of each of the first, second, third, and fourth drivers 114a, 114b, 114c, and 114d and the pick-up location of the passenger 116 is “2.5 Kms”, “3 Kms”, “7 Kms” and “4 Kms”, respectively. In one scenario where the available drivers are ranked in the ascending order, the ranking engine 206 may obtain the second set of ranked drivers including the first driver 114a (“2.5 Kms”), followed by the second driver 114b (“3 Kms”), the fourth driver 114d (“4 Kms”), and the third driver 114c (“7 Kms”). In another scenario where the available drivers are ranked in the descending order, the ranking engine 206 may obtain the second set of ranked drivers including the third driver 114c (“7 Kms”), followed by the fourth driver 114d (“4 Kms”), the second driver 114b (“3 Kms”), and the first driver 114a (“2.5 Kms”).

In another embodiment, the ranking engine 206 may rank the available drivers based on the traffic stopover duration of each available driver and generate the ranking information including the third set of ranked drivers. The drivers may be ranked in an ascending order or a descending order of their traffic stopover durations. For example, the traffic stopover durations associated with the first, second, third, and fourth drivers 114a, 114b, 114c, and 114d are “50 minutes”, “45 minutes”, “85 minutes” and “110 minutes”, respectively. In one scenario where the available drivers are ranked in the ascending order, the ranking engine 206 may obtain the third set of ranked drivers including the second driver 114b (“45 minutes”), followed by the first driver 114a (“50 minutes”), the third driver 114c (“85 minutes”), and the fourth driver 114d (“110 minutes”). In another scenario where the available drivers are ranked in the descending order of their traffic stopover durations, the ranking engine 206 may obtain the third set of ranked drivers including the fourth driver 114d (“110 minutes”), followed by the third driver 114c (“85 minutes”), the first driver 114a (“50 minutes”), and the second driver 114b (“45 minutes”).

A person having ordinary skill in the art will understand that the scope of the disclosure is not limited to ranking of the drivers based on only one parameter, such as the logged-in time duration of each available driver, the distance between the current location of each available driver and the pick-up location of the passenger 116, or the traffic stopover duration for each available driver. The available drivers in the set of available drivers 114 may be ranked based on one or more combinations of one or more parameters, such as the logged-in time duration of each available driver, the distance between the current location of each available driver and the pick-up location of the passenger 116, or the traffic stopover duration for each available driver, without limiting the scope of the disclosure. For example, values of two or more parameters may be normalized using one or more normalization techniques know in the art, to obtain a normalized score for each available driver. Thereafter, the available drivers of the set of available drivers 114 may be ranked based on the normalized score associated with each available driver.

After generating the ranking information, as described above, the ranking engine 206 may be configured to store the ranking information including the set of ranked drivers (i.e., the first, second, or third set of ranked drivers) in the memory 204. Thereafter, the allocation engine 202 may initiate an identification process for identifying a driver from the set of ranked drivers, who may be allocated to the passenger 116 for the rental ride.

In an embodiment, the allocation engine 202 may be configured to identify the subset of drivers from the first set of ranked drivers based on at least one of the logged-in time duration of each driver, the ride-time duration, and the first time duration. For each driver in the first set of ranked drivers, the allocation engine 202 may determine a summation value by summing the logged-in time duration and the ride-time duration. Thereafter, the allocation engine 202 may compare the summation value (determined for each driver in the first set of ranked drivers) with the first time duration. Based on the comparison, the allocation engine 202 may be configured to identify and select the subset of drivers from the first set of ranked drivers. In one example, the subset of drivers may include one or more drivers identified from the first set of ranked drivers such that the summation value of each of the one or more drivers in the subset of drivers is less than or equal to the first time duration. For example, the logged-in time durations of the first, second, third, and fourth drivers 114a, 114b, 114c, and 114d are “3 hours”, “2.5 hours”, “7 hours”, and “4 hours”, respectively. Further, the ride-time duration of the rental ride requested by the passenger 116 is “4 hours” and the first time duration is “9 hours”. In such a scenario, the subset of drivers includes the first, second, and fourth drivers 114a, 114b, and 114d as the respective summation value (e.g., “7 hours”, “6.5 hours”, and “8 hours”) is less than the first time duration “9 hours”. In another example, the subset of drivers may include one or more drivers identified from the first set of ranked drivers such that the summation value of each of the one or more drivers in the subset of drivers is greater than the first time duration. For example, the logged-in time durations of the first, second, third, and fourth drivers 114a, 114b, 114c, and 114d are “3 hours”, “2.5 hours”, “7 hours”, and “4 hours”, respectively, the ride-time duration is “4 hours”, and the first time duration is “9 hours”. In such a scenario, the subset of drivers includes the third driver 114c as the summation value (e.g., “11 hours”) is greater than the first time duration “9 hours”.

In an embodiment, the first time duration may be a time duration that is defined by an individual, for example, administrative personnel associated with the vehicle service provider. In another exemplary embodiment, the first time duration may be a time duration that is determined by the allocation engine 202 based on at least the ride time duration associated with the rental ride, the working hours of each driver, the log-in or log-out time of each driver, or any combination thereof.

Upon identification of the subset of drivers, the allocation engine 202 may be further configured to identify and select a driver from the subset of drivers based on the logged-in time duration of each of the subset of drivers and at least one of the ride-time duration, the probability of extending the rental ride by the passenger 116, or the destination location (e.g., a home location) of each of the subset of drivers. In one exemplary embodiment, the driver may be identified and selected from the subset of drivers when the logged-in time duration of the driver is less than the logged-in time durations of remaining drivers in the subset of drivers and the ride-time duration is greater than a second time duration. For example, the subset of drivers includes the first, second, and fourth drivers 114a, 114b, and 114d having the logged-in time durations of “3 hours”, “2.5 hours”, and “4 hours”, respectively. Further, the ride time duration of the rental ride requested by the passenger 116 is “4 hours”, and the second time duration is “3.5 hours”. Here, the ride-time duration is greater than the second time duration (i.e., “4 hours”>“3.5 hours”), and thus the booking request for the rental ride may be identified as a high package request. In such a scenario, the allocation engine 202 may identify and select the second driver 114b from the subset of drivers as the logged-in time duration “2.5 hours” of the second driver 114b is less than the logged-in time durations “3 hours” and “4 hours” of the first and fourth drivers 114a and 114d, respectively. Thereafter, the allocation engine 202 may be configured to allocate the second vehicle 112b associated with the second driver 114b to the passenger 116 for the rental ride. In a scenario where the second driver 114b may reject the booking request for the rental ride, the allocation engine 202 may identify the first driver 114a as the logged-in time duration “3 hours” of the first driver 114a is less than the logged-in time duration “4 hours” of the fourth driver 114d. Thereafter, the allocation engine 202 may allocate the first vehicle 112a associated with the first driver 114a to the passenger 116 for the rental ride.

In another exemplary embodiment, the driver may be identified and selected from the subset of drivers when the logged-in time duration of the driver is less than the logged-in time durations of remaining drivers in the subset of drivers and the probability of extending the rental ride is greater than a first threshold value. For example, the subset of drivers includes the first, second, and fourth drivers 114a, 114b, and 114d having the logged-in time durations of “3 hours”, “2.5 hours”, and “4 hours”, respectively. Further, the probability of extending the rental ride by the passenger 116 is “0.6” and the first threshold value is “0.5”. Here, the probability of extending the rental ride by the passenger 116 is greater than the first threshold value (i.e., “0.6”>“0.5”). In such a scenario, the allocation engine 202 may identify and select the second driver 114b from the subset of drivers as the logged-in time duration “2.5 hours” of the second driver 114b is less than the logged-in time durations “3 hours” and “4 hours” of the first and fourth drivers 114a and 114d, respectively. Thereafter, the allocation engine 202 may be configured to allocate the second vehicle 112b associated with the second driver 114b to the passenger 116 for the rental ride. In a scenario where the second driver 114b may reject the booking request for the rental ride, the allocation engine 202 may identify the first driver 114a as the logged-in time duration “3 hours” of the first driver 114a is less than the logged-in time duration “4 hours” of the fourth driver 114d. Thereafter, the allocation engine 202 may allocate the first vehicle 112a associated with the first driver 114a to the passenger 116 for the rental ride.

In another exemplary embodiment, the driver may be identified and selected from the subset of drivers when the logged-in time duration of the driver is greater than the logged-in time durations of remaining drivers in the subset of drivers and the destination location of the driver is within a defined radial distance of the drop-off location associated with the rental ride. For example, the subset of drivers includes the first, second, and fourth drivers 114a, 114b, and 114d having the logged-in time durations of “3 hours”, “2.5 hours”, and “4 hours”, respectively. Further, the destination location (i.e., the home location) of the first, second, and fourth drivers 114a, 114b, and 114d are first, second, and fourth home locations, respectively, and the drop-off location associated with the rental ride is predicted as a rental drop-off location. The rental drop-off location for the passenger 116 may be predicted based on the historical rental data of the passenger 116. In one example, each of the first, second, and fourth home locations is within the defined radial distance of the rental drop-off location associated with the rental ride. In such a scenario, the allocation engine 202 may identify and select the fourth driver 114d from the subset of drivers as the logged-in time duration “4 hours” of the fourth driver 114d is greater than the logged-in time durations “3 hours” and “2.5 hours” of the first and second drivers 114a and 114b, respectively. Thereafter, the allocation engine 202 may be configured to allocate the fourth vehicle 112d associated with the fourth driver 114d to the passenger 116 for the rental ride. In another example, two of the first, second, and fourth home locations, for example, the first and fourth home locations are within the defined radial distance of the rental drop-off location associated with the rental ride. In such a scenario, the allocation engine 202 may identify and select the fourth driver 114d from the subset of drivers as the logged-in time duration “4 hours” of the fourth driver 114d is greater than the logged-in time duration “3 hours” of the first driver 114a. Thereafter, the allocation engine 202 may be configured to allocate the fourth vehicle 112d associated with the fourth driver 114d to the passenger 116 for the rental ride.

In another embodiment, the allocation engine 202 may be configured to identify and select the driver from the second set of ranked drivers when the probability of cancelling the booking request (by the passenger 116) is greater than a second threshold value. The driver may be identified and selected from the second set of ranked drivers based on the current location of each driver in the second set of ranked drivers and the pick-up location of the passenger 116. In one embodiment, the driver may be identified and selected from the second set of ranked drivers based on the distance between the current location of each driver in the second set of ranked drivers and the pick-up location of the passenger 116. For example, the driver may be identified and selected from the second set of ranked drivers when the distance between the driver and the passenger 116 is less than the distance between each of remaining drivers in the second set of ranked drivers and the passenger 116. For example, the allocation engine 202 may identify and select the first driver 114a from the second set of ranked drivers as the distance between the first driver 114a and the passenger 116 (e.g., “2.5 Kms”) is less than the distance between the second driver 114b and the passenger 116 (e.g., “3 Kms”), the distance between the third driver 114c and the passenger 116 (e.g., “7 Kms”), and the distance between the fourth driver 114d and the passenger 116 (e.g., “4 Kms”). Thereafter, the allocation engine 202 may be configured to allocate the first vehicle 112a associated with the first driver 114a to the passenger 116 for the rental ride.

In another embodiment, the driver may be identified and selected from the second set of ranked drivers when the distance between the driver and the passenger 116 is less than the distance between each of remaining drivers in the second set of ranked drivers and the passenger 116 and the number of cancelled booking requests associated with the driver is less than the number of cancelled booking requests associated with the remaining drivers in the second set of ranked drivers. For example, the allocation engine 202 may identify and select the first driver 114a from the second set of ranked drivers as the distance between the first driver 114a and the passenger 116 (e.g., “2.5 Kms”) is less than the distances “3 Kms”, “7 Kms”, and “4 Kms” between each of the second, third, and fourth drivers 114b, 114c, and 114d and the passenger 116, respectively. Further, the number of cancelled booking requests associated with the first driver 114a is less than the number of cancelled booking requests associated with the second, third, and fourth drivers 114b, 114c, and 114d. Thereafter, the allocation engine 202 may be configured to allocate the first vehicle 112a associated with the first driver 114a to the passenger 116 for the rental ride.

In another embodiment, the allocation engine 202 may be configured to identify and select the driver from the third set of ranked drivers based on at least one of the traffic stopover duration, the number of cancelled booking requests, or the driver category associated with each of the third set of ranked drivers. In one embodiment, the driver may be identified and selected from the third set of ranked drivers when the traffic stopover duration of the driver is greater than the traffic stopover duration of each of remaining drivers in the third set of ranked drivers. For example, the allocation engine 202 may identify and select the fourth driver 114d from the third set of ranked drivers as the traffic stopover duration “110 minutes” associated with the fourth driver 114d is greater than the traffic stopover durations “50 minutes”, “45 minutes”, and “85 minutes” associated with the first, second, and third drivers 114a, 114b, and 114c, respectively. Thereafter, the allocation engine 202 may be configured to allocate the fourth vehicle 112d associated with the fourth driver 114d to the passenger 116 for the rental ride.

In another embodiment, the driver may be identified and selected from the third set of ranked drivers when the number of cancelled booking requests associated with the driver is greater than the number of cancelled booking requests associated with each of the remaining drivers in the third set of ranked drivers. For example, the number of cancelled booking requests associated with the second driver 114b is greater than the number of cancelled booking requests associated with the first, third, and fourth drivers 114a, 114c, and 114d. Thus, the allocation engine 202 may identify and select the second driver 114b from the third set of ranked drivers and allocate the second vehicle 112b associated with the second driver 114b to the passenger 116 for the rental ride.

In another embodiment, the driver may be identified and selected from the third set of ranked drivers based on the driver category associated with each of the third set of ranked drivers. The driver category may correspond to a first category (e.g., mini drivers), a second category (e.g., micro drivers), a third category (e.g., prime drivers), or the like. Further, a first ride fare associated with the first category is less than a second ride fare associated with the second category and a third ride fare associated with the third category. Also, the second ride fare is less than the third ride fare. In a scenario where any driver in the third set of ranked drivers is associated with the third category, but may be engaged with rides from the first or second category, the allocation engine 202 may identify such driver, for example, the third driver 114c and allocate the third vehicle 112c associated with the third driver 114c to the passenger 116 for the rental ride.

Upon allocation of the most suitable driver (identified and selected from the set of available drivers 114) and the associated vehicle to the passenger 116, as described above, the allocation engine 202 may be configured to generate and communicate the allocation information to the passenger 116 as well as the allocated driver to the passenger 116. Furthermore, the allocation engine 202 may be configured to generate a customized digital map based on the allocation information and communicate the customized digital map to the allocated driver. The allocated driver may utilize the customized digital map to navigate between the plurality of locations while offering the rental ride to the passenger 116. Such customized digital map may help the allocated driver to save time, money, and fuel while navigating between the plurality of locations. Also, the passenger 116 may experience an enhanced and comfortable ride, which may further help to maximize demand for such ride services offered by the vehicle service provider.

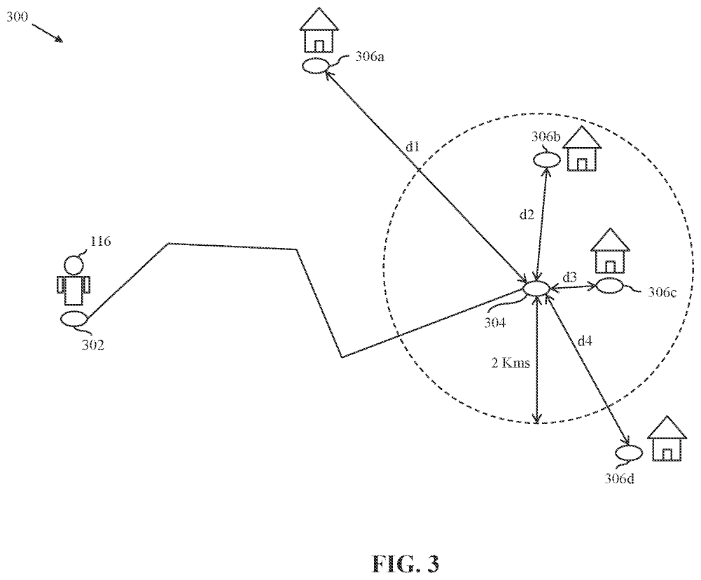

FIG. 3 is a vehicle allocation environment 300 for allocating vehicles to passengers, in accordance with an exemplary embodiment of the disclosure. The vehicle allocation environment 300 shows a passenger (such as the passenger 116) who is currently located at a pick-up location 302. The passenger 116 may initiate the booking request for the rental ride. The vehicle allocation environment 300 further shows a rental drop-off location 304 associated with the passenger 116. The rental drop-off location 304 may be predicted based on the historical rental data of the passenger 116. The vehicle allocation environment 300 further shows first, second, third, and fourth home locations 306a, 306b, 306c, and 306d associated with the first, second, third, and fourth drivers 114a, 114b, 114c, and 114d, respectively. Further, dl indicates a first distance between the rental drop-off location 304 and the first home location 306a, d2 indicates a second distance between the rental drop-off location 304 and the second home location 306b, d3 indicates a third distance between the rental drop-off location 304 and the third home location 306c, and d4 indicates a fourth distance between the rental drop-off location 304 and the fourth home location 306d.

The allocation engine 202 may receive the booking request for the rental ride from the passenger device 108 of the passenger 116. In the current example, the ride-time duration of the rental ride is “5 hours” and the second time duration is “4 hours”. Since the ride-time duration is greater than the second time duration (“5 hours”>“4 hours”), the allocation engine 202 may determine that the booking request is a high package request. The allocation engine 202 may further determine the probability of extending the rental ride by the passenger 116. For example, the number of rental rides availed by the passenger 116 in the past is “10” and the number of rental rides extended by the passenger 116 in the past is “6”. The probability of extending the rental ride by the passenger 116 may be determined as a ratio of the number of rental rides extended by the passenger 116 and the number of rental rides availed by the passenger 116 i.e., “0.6”, which is greater than the first threshold value “0.5”.

Further, the first set of ranked drivers includes the first, second, third, and fourth drivers 114a, 114b, 114c, and 114d associated with the first, second, third, and fourth vehicles 112a, 112b, 112c, and 112d, respectively. The logged-in time duration of each of the first, second, third, and fourth drivers 114a, 114b, 114c, and 114d is “1 hour”, “3 hours”, “9 hours”, and “4 hours”, respectively. In the current example, the first time duration is “10 hours”. The allocation engine 202 may be configured to identify and select the subset of drivers from the first set of ranked drivers such that the summation value (i.e., a sum of the logged-in time duration and the ride-time duration) for each driver in the subset of drivers is less than the first time duration (i.e., “10 hours”). Thus, in the ongoing example, the subset of drivers includes the first, second, and fourth drivers 114a, 114b, and 114d having the logged-in time durations “1 hour”, “3 hours”, and “4 hours”, respectively. The allocation engine 202 may further identify the first driver 114a from the subset of drivers, who is associated with the least logged-in time duration among the drivers in the subset of drivers. The allocation engine 202 further allocates the first vehicle 112a associated with the first driver 114a to the passenger 116 for the rental ride.

In another example, the logged-in time duration of each of the first, second, third, and fourth drivers 114a, 114b, 114c, and 114d is “5 hours”, “8 hours”, “7 hours”, and “6 hours”, respectively, the ride-time duration is “4 hours”, and the first time duration is “8 hours”. Thus, none of the drivers from the set of available drivers 114 is associated with the summation value that is less than the first time duration. In such a scenario, the allocation engine 202 may be configured to identify and select the subset of drivers including one or more drivers from the set of available drivers 114 such that the summation value is greater than the first time duration. The allocation engine 202 may further predict the rental drop-off location 304 for the passenger 116 based on the historical rental data of the passenger 116. The allocation engine 202 may further determine the first, second, third, and fourth home locations 306a, 306b, 306c, and 306d associated with the first, second, third, and fourth drivers 114a, 114b, 114c, and 114d, respectively. In the current example, the defined radial distance is “2 kms”. The allocation engine 202 may further determine the first distance (d1), the second distance (d2), the third distance (d3), and the fourth distance (d4) based on the rental drop-off location 304 and the first, second, third, and fourth home locations 306a, 306b, 306c, and 306d associated with the first, second, third, and fourth drivers 114a, 114b, 114c, and 114d, respectively. In the current example, the first distance (d1), the second distance (d2), the third distance (d3), and the fourth distance (d4) are equal to “4 Kms”, “1 Kms”, “0.5 Km”, and “3 Kms”, respectively. Based on the defined radial distance and the first distance (d1), the second distance (d2), the third distance (d3), and the fourth distance (d4), the allocation engine 202 may be configured to determine that the first and fourth home locations 306a and 306d are outside the defined radial distance (“2 Kms”), and thus, the first and fourth drivers 114a and 114d associated with the first and fourth home locations 306a and 306d, respectively, are not considered for allocation to the passenger 116. The second and third home locations 306b and 306c are within the defined radial distance (“2 Kms”). In one embodiment, the allocation engine 202 may allocate one of the second and third drivers 114b and 114c associated with the second and third home locations 306b and 306c, respectively, to the passenger 116 for the rental ride. In another embodiment, the allocation engine 202 may identify and select the third driver 114c from the second and third drivers 114b and 114c as the home location (i.e., the third home location 306c) of the third driver 114c is nearest to the rental drop-off location 304 of the passenger 116.

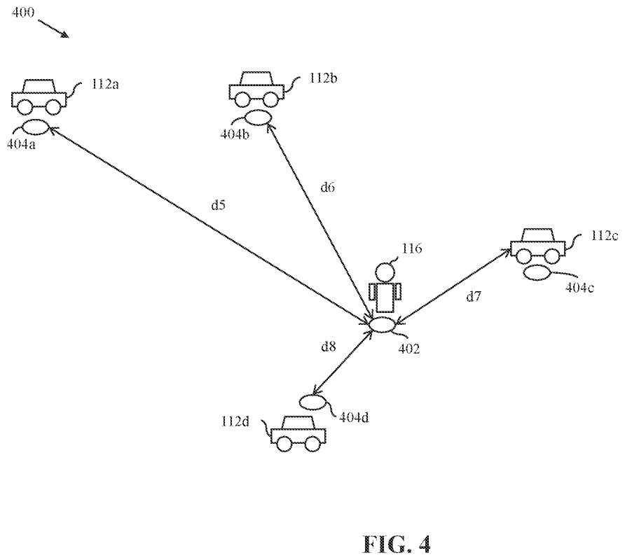

FIG. 4 is a vehicle allocation environment 400 for allocating vehicles to passengers, in accordance with another exemplary embodiment of the disclosure. The vehicle allocation environment 400 shows a passenger (such as the passenger 116) who is currently located at a pick-up location 402. The vehicle allocation environment 400 further shows first, second, third, and fourth current locations 404a, 404b, 404c, and 404d associated with the first, second, third, and fourth vehicles 112a, 112b, 112c, and 112d, respectively. Further, d5 indicates a first distance between the first current location 404a and the pick-up location 402, d6 indicates a second distance between the second current location 404b and the pick-up location 402, d7 indicates a third distance between the third current location 404c and the pick-up location 402, and d8 indicates a fourth distance between the fourth current location 404d and the pick-up location 402.

The passenger device 108 may transmit the booking request, initiated by the passenger 116, to the transportation server 104. The allocation engine 202 may receive the booking request for the rental ride from the passenger device 108 and process the booking request to determine the pick-up location 402 for the rental ride. The allocation engine 202 may further determine the probability of cancelling the booking request by the passenger 116. In the current example, the number of booking requests initiated by the passenger 116 before initiating the current booking request is “10” and the number of booking requests cancelled by the passenger 116 is “8”. The probability of cancelling the booking request may be determined as a ratio of the number of booking requests cancelled by the passenger 116 and the number of booking requests initiated by the passenger 116 i.e., “0.8”, which is greater than the second threshold value (i.e., “0.8”>“0.5”).

Further, the set of available drivers 114 includes the first, second, third, and fourth drivers 114a, 114b, 114c, and 114d associated with the first, second, third, and fourth vehicles 112a, 112b, 112c, and 112d, respectively. The allocation engine 202 may determine the first distance (d5), the second distance (d6), the third distance (d7), and the fourth distance (d8) based on the first, second, third, and fourth current locations 404a, 404b, 404c, and 404d and the pick-up location 402. For example, the first distance (d5), the second distance (d6), the third distance (d7), and the fourth distance (d8) are “8 Kms”, “6 Kms”, “4 Kms”, and “2 Kms”, respectively. The ranking engine 206 may rank the drivers of the set of available drivers 114, based on the first distance (d5), the second distance (d6), the third distance (d7), and the fourth distance (d8), to obtain the second set of ranked drivers. The allocation engine 202 may further identify and select the fourth driver 114d from the second set of ranked drivers as the fourth distance (d8) is less than the first distance (d5), the second distance (d6), and the third distance (d7). The allocation engine 202 may further allocate the fourth vehicle 112d associated with the fourth driver 114d to the passenger 116 for the rental ride.

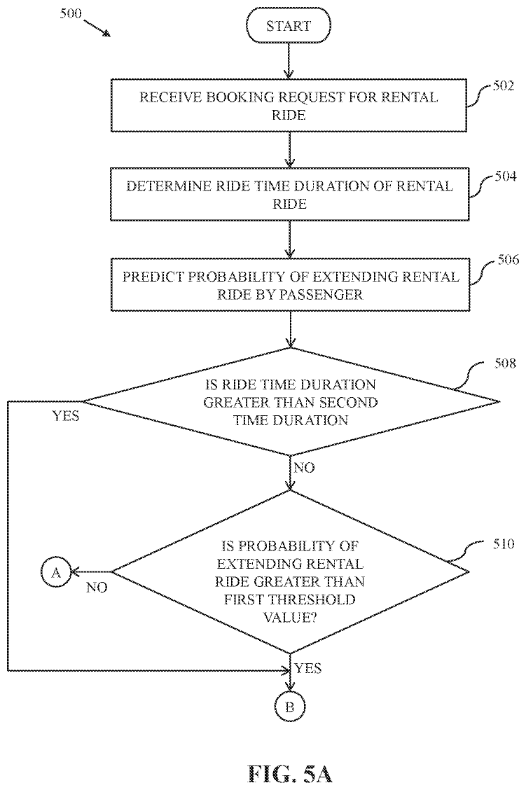

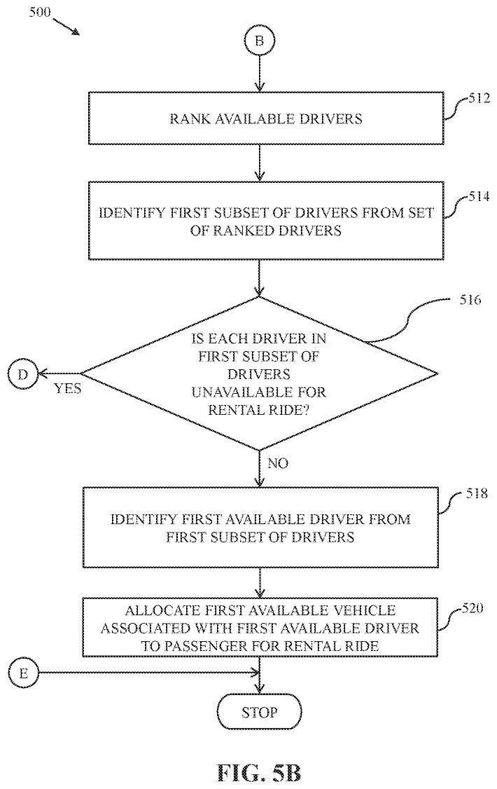

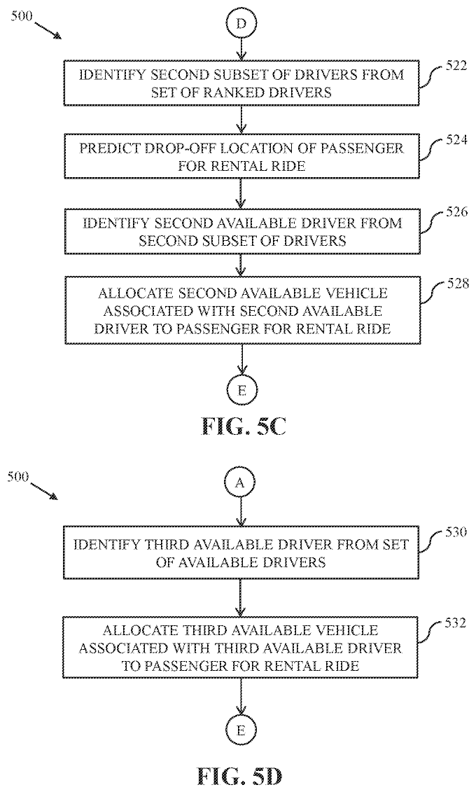

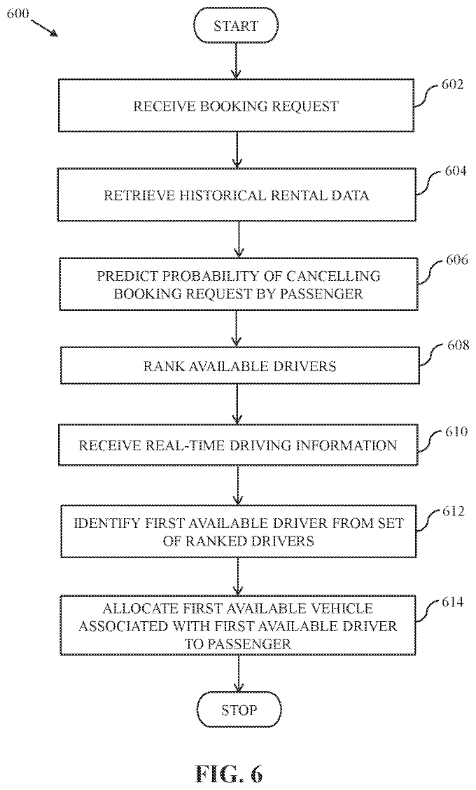

FIGS. 5A-5D, collectively, illustrates a flow chart 500 of a method for allocating vehicles to passengers, in accordance with an exemplary embodiment of the disclosure.

At 502, the booking request for rental ride is received. In an embodiment, the allocation engine 202 may be configured to receive the booking request for the rental ride from the passenger device 108 of the passenger 116. At 504, the ride time duration of the rental ride is determined. In an embodiment, the allocation engine 202 may be configured to determine the ride-time duration of the rental ride. For example, the ride-time duration may be determined based on the booking request.

At 506, the probability of extending the rental ride by the passenger 116 is predicted. In an embodiment, the allocation engine 202 may be configured to predict the probability of extending the rental ride by the passenger 116. For example, the probability of extending the rental ride by the passenger 116 may be predicted based on the historical rental data of the passenger 116.

At 508, a check is performed to determine whether the ride-time duration of the rental ride is greater than the second time duration. In an embodiment, the allocation engine 202 may be configured to perform the check to determine whether the ride-time duration is greater than the second time duration or not. At 508, if the allocation engine 202 determines that the ride-time duration is not greater than the second time duration, then 510 is performed, else 512 is performed.

At 510, a check is performed to determine whether the probability of extending the rental ride by the passenger 116 is greater than the first threshold value. In an embodiment, the allocation engine 202 may be configured to perform the check to determine whether the probability of extending the rental ride by the passenger 116 is greater than the first threshold value or not. At 510, if the allocation engine 202 determines that the probability of extending the rental ride by the passenger 116 is greater than the first threshold value, then 512 is performed, else 530 is performed.

At 512, available drivers (such as the set of available drivers 114) are ranked. In an embodiment, the ranking engine 206 may be configured to rank the set of available drivers 114 based on the logged-in time duration of each available driver in the set of available drivers 114 and obtain the set of ranked drivers such as the first set of ranked drivers.

At 514, a first subset of drivers is identified from the first set of ranked drivers. In an embodiment, the allocation engine 202 may be configured to identify the first subset of drivers from the first set of ranked drivers based on at least the logged-in time duration of each driver in the first subset of drivers and at least one of the ride-time duration of the rental ride and the first time duration. For example, the first subset of drivers may be identified from the first set of ranked drivers such that a sum of the ride-time duration and the logged-in time duration of each driver in the first subset of drivers is less than the first time duration.

At 516, a check is performed to determine whether each driver from the first subset of drivers is unavailable for the rental ride. In an embodiment, the allocation engine 202 may be configured to perform the check to determine whether each driver from the first subset of drivers is unavailable for the rental ride or one or more drivers from the first subset of drivers are available for the rental ride. If, at 516, the allocation engine 202 determines that the one or more drivers from the first subset of drivers are available for the rental ride, then 518 is performed, else 522 is performed.

At 518, a first available driver is identified from the first subset of drivers. In an embodiment, the allocation engine 202 may be configured to identify the first available driver (e.g., the first driver 114a) from the first subset of drivers.

At 520, a first available vehicle associated with the first available driver is allocated to the passenger 116 for the rental ride. In an embodiment, the allocation engine 202 may be configured to allocate the first available vehicle associated with the first available driver (e.g., the first vehicle 112a associated with the first driver 114a) to the passenger 116 for the rental ride.

At 522, a second subset of drivers is identified from the first set of ranked drivers. In an embodiment, the allocation engine 202 may be configured to identify the second subset of drivers from the first set of ranked drivers based at least the logged-in time duration of each driver in the second subset of drivers and at least one of the ride-time duration of the rental ride and the first time duration. For example, the second subset of drivers may be identified from the first set of ranked drivers such that a sum of the rental-time duration and the logged-in time duration of each driver in the second subset of drivers is greater than the first time duration.

At 524, the drop-off location of the passenger 116 is predicted for the rental ride. In an embodiment, the allocation engine 202 may be configured to predict the drop-off location of the passenger 116 based on the historical rental data of the passenger 116.

At 526, a second available driver is identified from the second subset of drivers. In an embodiment, the allocation engine 202 may be configured to identify the second available driver (e.g., the third driver 114c) from the second subset of drivers. At 528, a second available vehicle associated with the second available driver is allocated to the passenger 116 for the rental ride. In an embodiment, the allocation engine 202 may be configured to allocate the second available vehicle associated with the second available driver (e.g., the third vehicle 112c associated with the third driver 114c) to the passenger 116 for the rental ride.

At 530, a third available driver is identified from the set of available drivers 114. In an embodiment, the allocation engine 202 may be configured to identify the third available driver from the set of available drivers 114. The third available driver may be identified from the set of available drivers 114 based on at least the logged-in duration of each available driver in the set of available drivers 114. At 532, a third available vehicle associated with the third available driver is allocated to the passenger 116 for the rental ride. In an embodiment, the allocation engine 202 may be configured to allocate the third available vehicle associated with the third available driver to the passenger 116 for the rental ride.

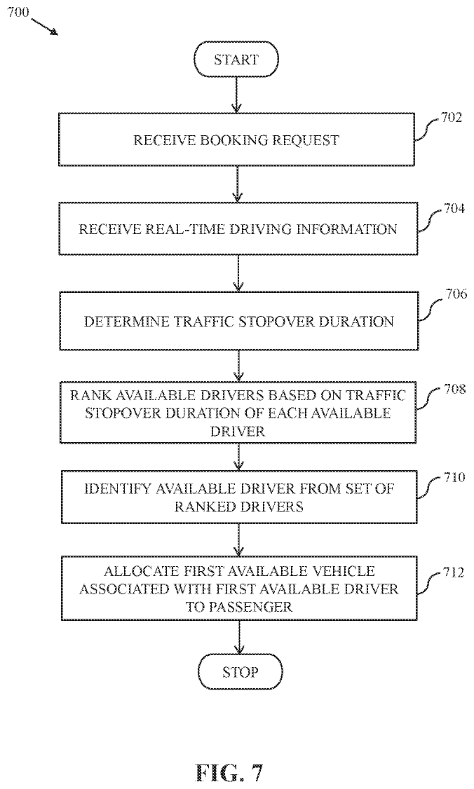

FIG. 6 illustrates a flow chart 600 of a method for allocating vehicles to passengers, in accordance with another exemplary embodiment of the disclosure.

At 602, the booking request is received. In an embodiment, the allocation engine 202 may be configured to receive the booking request for the rental ride from the passenger device 108 of the passenger 116. The booking request may include at least the pick-up location of the passenger 116.

At 604, the historical rental data is retrieved. In an embodiment, the allocation engine 202 may be configured to retrieve the historical rental data of the passenger 116 from the database server 102. The historical rental data may include at least the number of booking requests initiated by the passenger 116 for the rental rides and the number of booking requests cancelled by the passenger 116 in the past.

At 606, the probability of cancelling the booking request by the passenger 116 is predicted. In an embodiment, the allocation engine 202 may be configured to predict the probability of cancelling the booking request by the passenger 116 based on the historical rental data of the passenger 116.

At 608, available drivers (such as the set of available drivers 114) are ranked. In an embodiment, the ranking engine 206 may be configured to rank the set of available drivers 114 based on a distance between the current location of each available driver in the set of available drivers 114 and the pick-up location of the passenger 116 and obtain the set of ranked drivers such as the second set of ranked drivers.

At 610, the real-time driving information is received. In an embodiment, the allocation engine 202 may be configured to receive the real-time driving information from various driver devices (such as the set of driver devices 106) of various drivers (such as the set of drivers 114) in the second set of ranked drivers. The real-time driving information may include at least the logged-in time and the number of cancelled booking requests associated with each driver.

At 612, a first available driver is identified from the second set of ranked drivers. In an embodiment, the allocation engine 202 may be configured to identify the first available driver (e.g., the fourth driver 114d) from the second set of ranked drivers based on the current location of each driver in the second set of ranked drivers and the pick-up location of the passenger 116, when the probability of cancelling the booking request by the passenger 116 is greater than the second threshold value. In one example, the first available driver may be identified when the distance between the first available driver and the passenger 116 is less than the distance between each of remaining drivers in the second set of ranked drivers and the passenger 116. In another example, the first available driver may be identified when the distance between the first available driver and the passenger 116 is less than the distance between each of remaining drivers in the second set of ranked drivers and the passenger 116, and the number of cancelled booking requests associated with the first available driver is less than the number of cancelled booking requests associated with the remaining drivers.

At 614, a first available vehicle associated with the first available driver is allocated to the passenger 116. In an embodiment, the allocation engine 202 may be configured to allocate the first available vehicle associated with the first available driver (e.g., the fourth vehicle 112d associated with the fourth driver 114d) to the passenger 116 for the rental ride.

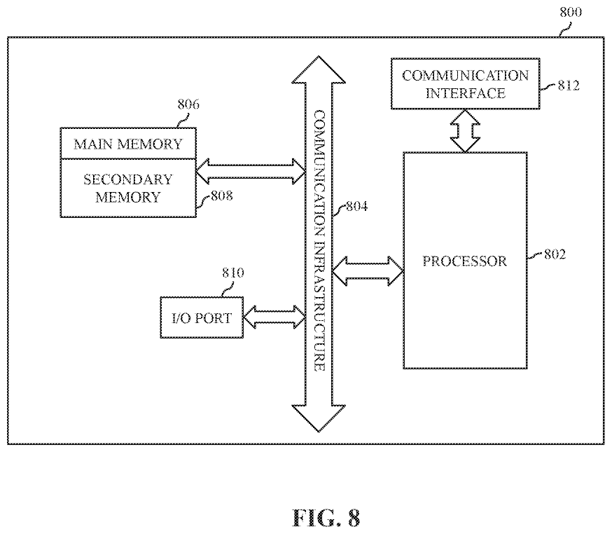

FIG. 7 illustrates a flow chart 700 of a method for allocating vehicles to passengers, in accordance with another exemplary embodiment of the disclosure.

At 702, the booking request is received. In an embodiment, the allocation engine 202 may be configured to receive the booking request for the rental ride from the passenger device 108 of the passenger 116.

At 704, the real-time driving information is received. In an embodiment, the allocation engine 202 may be configured to receive the real-time driving information from various driver devices (such as the set of driver devices 106) of various drivers (such as the set of drivers 114). The real-time driving information may include at least the driving pattern information and the number of cancelled booking requests associated with each driver in the set of drivers 114 associated with the set of driver devices 106.

At 706, the traffic stopover duration is determined. In an embodiment, the allocation engine 202 may be configured to determine the traffic stopover duration for each available driver in the set of available drivers 114 based on the real-time driving information of each driver. The traffic stopover duration for each driver may be determined during the logged-in time duration of each driver. For example, the traffic stopover durations of the first, second, third, and fourth drivers 114a, 114b, 114c, and 114d are “3 hours”, “4 hours”, “1 hour”, and “2 hours”, respectively, and the logged-in time durations of the first, second, third, and fourth drivers 114a, 114b, 114c, and 114d are “4 hours”, “8 hours”, “5 hours”, and “6 hours”, respectively.

At 708, available drivers (such as the set of available drivers 114) are ranked based on the traffic stopover duration of each available driver. In an embodiment, the ranking engine 206 may be configured to rank the set of available drivers 114 based on the traffic stopover duration of each available driver and obtain the set of ranked drivers such as the third set of ranked drivers. In one example, the ranking engine 206 may rank the set of available drivers 114 based on highest to lowest traffic stopover durations. In another example, the ranking engine 206 may determine a ratio of the traffic stopover duration and the logged-in time duration for each driver in the set of available drivers 114. Thereafter, the ranking engine 206 may rank the set of available drivers 114 based on the determined ratios. For example, the determined ratios for the first, second, third, and fourth drivers 114a, 114b, 114c, and 114d are “0.75”, “0.5”, “0.2”, and “0.3”, respectively.

At 710, a first available driver is identified from the third set of ranked drivers. In an embodiment, the allocation engine 202 may be configured to identify the first available driver from the third set of ranked drivers based on at least one of the traffic stopover duration, the number of cancelled booking requests, or the driver category associated with each of the third set of ranked drivers. In one example, the first available driver (e.g., the second driver 114b) may be identified from the third set of ranked drivers when the traffic stopover duration of the first available driver is greater than traffic stopover durations of remaining drivers (e.g., the first, third, and fourth drivers 114a, 114c, and 114d) in the third set of ranked drivers. In another example, the first available driver (e.g., the first driver 114a) may be identified from the third set of ranked drivers when the determined ratio of the first available driver is greater than the determined ratios of remaining drivers (e.g., the second, third, and fourth drivers 114b, 114c, and 114d) in the third set of ranked drivers. In another example, the first available driver may be identified from the third set of ranked drivers when the number of cancelled booking requests for the first available driver is greater than the number of cancelled booking requests for each of remaining drivers in the third set of ranked drivers. In another example, the first available driver may be identified from the third set of ranked drivers when the number of cancelled booking requests for the first available driver is greater than the number of cancelled booking requests for each of remaining drivers in the third set of ranked drivers.

At 712, a first available vehicle associated with the first available driver is allocated to the passenger 116. In an embodiment, the allocation engine 202 may be configured to allocate the first available vehicle associated with the first available driver (e.g., the first vehicle 112a or the second vehicle 112b associated with the first driver or the second driver 114a or 114b, respectively) to the passenger 116 for the rental ride.

Referring now to FIG. 8, a block diagram is shown that illustrates a computer system 800 for allocating vehicles to passengers, in accordance with an exemplary embodiment of the disclosure. An embodiment of the present disclosure, or portions thereof, may be implemented as computer readable code on the computer system 800. In one example, the database server 102 and the transportation server 104 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5A-5D, 6, and 7.

The computer system 800 includes a processor 802 that may be a special purpose or a general-purpose processing device. The processor 802 may be a single processor, multiple processors, or combinations thereof. The processor 802 may have one or more processor “cores.” Further, the processor 802 may be connected to a communication infrastructure 804, such as a bus, a bridge, a message queue, the communication network 110, multi-core message-passing scheme, and the like. The computer system 800 further includes a main memory 806 and a secondary memory 808. Examples of the main memory 806 may include a RAM, a ROM, and the like. The secondary memory 808 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 800 further includes an input/output (I/O) port 810 and a communication interface 812. The I/O port 810 includes various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communications port, and the like. Data transferred via the communication interface 812 may be signals, such as electronic, electromagnetic, optical, or other signals as will be apparent to a person skilled in the art. The signals may travel via a communications channel, such as the communication network 110, which may be configured to transmit the signals to the various devices that are communicatively coupled to the computer system 800. Examples of the communication channel may include, but not limited to, a cable, fiber optics, a phone line, a cellular phone link, a radio frequency link, a wireless link, and the like.

Computer program medium and computer usable medium may refer to memories, such as the main memory 806 and the secondary memory 808, which may be a semiconductor memory such as dynamic RAMs. These computer program mediums may provide data that enables the computer system 800 to implement the methods illustrated in FIGS. 5A-5D, 6, and 7. In an embodiment, the present disclosure is implemented using a computer implemented application. The computer implemented application may be stored in a computer program product and loaded into the computer system 800 using the removable storage drive or the hard disc drive in the secondary memory 808, the I/O port 810, or the communication interface 812.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 802, and a memory, such as the main memory 806 and the secondary memory 808, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the scope of the disclosed subject matter.

The vehicle allocation methods of FIGS. 5A-5D, 6, and 7 provide efficient and effective ways of allocating vehicles to the passenger 116 for the rental ride. The transportation server 104 processes the logged-in time durations of the drivers (such as the set of available drivers 114) associated with the vehicle service provider for allocation. If the booking request is a high package request or the passenger 116 tends to extend the rental ride beyond the ride-time duration or the ride distance, then an available vehicle associated with an available driver having least logged-in time duration may be preferred for allocation to the passenger 116. Thus, even if the rental ride is extended beyond the ride-time duration or the ride distance, the allocated driver can conveniently complete the rental ride and can earn more at the same time. The transportation server 104 also considers the home locations of the drivers for allocation. Therefore, if an available vehicle associated with an available driver having a long logged-in time duration is allocated to the passenger 116, then the allocated driver will have the home location close to the drop-off location of the passenger 116 so that the driver can accept and complete the rental ride without much discomfort. The transportation server 104 also considers the number of cancelled requests associated with the driver for allocation. Thus, if the passenger 116 tends to cancel the booking request, then an available vehicle associated with an available driver having a low number of cancelled booking requests may be allocated to the passenger 116. Further, the transportation server 104 allocates a nearby vehicle to the passenger 116 when the passenger 116 tends to cancel the booking request. The transportation server 104 also considers the traffic stopover duration of each available driver for allocation. Thus, an available driver who is stuck in traffic for a long time are preferred for the rental ride as opposed to other ride types. This way, the available driver is able to earn more by completing the rental ride. Also, the available driver, who has encountered a large number of cancelled booking requests due to being stuck in the traffic, is preferred for the rental ride. As an available driver can earn more from the rental ride, the available driver, who has been allocated with ride types having low ride costs, is preferred for the rental ride.

Techniques consistent with the present disclosure provide, among other features, vehicle allocation methods and systems for rental rides. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A vehicle allocation method, comprising:
receiving, by circuitry, from a passenger device of a passenger, a booking request for a fixed rental ride including at least a ride-time duration;
identifying, by the circuitry, a subset of drivers from a set of ranked drivers based on at least a logged-in time duration of each driver and the ride-time duration;
identifying, by the circuitry, a first driver from the subset of drivers based on the logged-in time duration of each of the subset of drivers and at least one of the ride-time duration, a probability of extending the fixed rental ride by the passenger, or a destination location of each of the subset of drivers; and
allocating, by the circuitry, a first vehicle associated with the first driver to the passenger for the fixed rental ride.

2. The vehicle allocation method of claim 1, further comprising ranking, by the circuitry, a set of available drivers based on the logged-in time duration of each driver in the set of available drivers, to obtain the set of ranked drivers.

3. The vehicle allocation method of claim 1, wherein each driver in the subset of drivers is identified from the set of ranked drivers when a sum of the logged-in time duration of each driver and the ride-time duration is less than or equal to a first time duration.

4. The vehicle allocation method of claim 1, wherein the first driver is further identified from the subset of drivers when the logged-in time duration of the first driver is less than logged-in time durations of remaining drivers in the subset of drivers and the ride-time duration is greater than a second time duration.

5. The vehicle allocation method of claim 1, wherein the first driver is further identified from the subset of drivers when the logged-in time duration of the first driver is less than logged-in time durations of remaining drivers in the subset of drivers and the probability of extending the fixed rental ride is greater than a threshold value.

6. The vehicle allocation method of claim 5, wherein the probability of extending the fixed rental ride is predicted based on historical rental data of the passenger.

7. The vehicle allocation method of claim 6, wherein the historical rental data of the passenger includes at least a number of fixed rental rides taken by the passenger and a number of fixed rental rides extended by the passenger beyond a corresponding fixed ride distance or ride-time duration.

8. The vehicle allocation method of claim 1, wherein the first driver is further identified from the subset of drivers when the logged-in time duration of the first driver is greater than logged-in time durations of remaining drivers in the subset of drivers and the destination location of the first driver is within a defined radial distance of a drop-off location associated with the fixed rental ride.

9. A vehicle allocation method, comprising:
receiving, by circuitry, from a passenger device of a passenger, a booking request for a fixed rental ride including at least a pick-up location of the passenger;
retrieving, by the circuitry, from a storage server, historical rental data of the passenger;
predicting, by the circuitry, a probability of cancelling the booking request by the passenger based on the historical rental data of the passenger;
identifying, by the circuitry, a first driver from a set of ranked drivers based on a current location of each driver in the set of ranked drivers and the pick-up location of the passenger, when the probability of cancelling the booking request is greater than a threshold value; and
allocating, by the circuitry, a first vehicle associated with the first driver to the passenger for the fixed rental ride.

10. The vehicle allocation method of claim 9, wherein the historical rental data of the passenger includes at least a number of booking requests initiated by the passenger for fixed rental rides and a number of booking requests cancelled by the passenger.

11. The vehicle allocation method of claim 9, further comprising ranking, by the circuitry, a set of available drivers based on a distance between the current location of each driver in the set of available drivers and the pick-up location of the passenger, to obtain the set of ranked drivers.

12. The vehicle allocation method of claim 11, wherein the first driver is further identified from the set of ranked drivers when the distance between the first driver and the passenger is less than the distance between each of remaining drivers in the set of ranked drivers and the passenger.

13. The vehicle allocation method of claim 11, further comprising receiving, by the circuitry, from a driver device of each driver in the set of ranked drivers, real-time driving information including at least a logged-in time and a number of cancelled booking requests associated with each driver.

14. The vehicle allocation method of claim 13, wherein the first driver is further identified from the set of ranked drivers when the distance between the first driver and the passenger is less than the distance between each of remaining drivers in the set of ranked drivers and the passenger, and the number of cancelled booking requests associated with the first driver is less than the number of cancelled booking requests associated with the remaining drivers.

15. A vehicle allocation method, comprising:
receiving, by circuitry, from a passenger device of a passenger, a booking request for a fixed rental ride;
determining, by the circuitry, a traffic stopover duration of each driver in a set of available drivers based on real-time driving information of each driver;
ranking, by the circuitry, the set of available drivers based on the traffic stopover duration of each driver, to obtain a set of ranked drivers;
identifying, by the circuitry, a first driver from the set of ranked drivers based on at least one of the traffic stopover duration, a number of cancelled booking requests, or a driver category associated with each of the set of ranked drivers; and
allocating, by the circuitry, a first vehicle associated with the first driver to the passenger for the fixed rental ride.

16. The vehicle allocation method of claim 15, further comprising receiving, by the circuitry, from a driver device of each driver, the real-time driving information including at least driving pattern information and the number of cancelled booking requests associated with each driver.

17. The vehicle allocation method of claim 15, wherein the first driver is further identified from the set of ranked drivers when the traffic stopover duration of the first driver is greater than traffic stopover durations of remaining drivers in the set of ranked drivers.

18. The vehicle allocation method of claim 15, wherein the first driver is further identified from the set of ranked drivers when the number of cancelled booking requests for the first driver is greater than the number of cancelled booking requests for each of remaining drivers in the set of ranked drivers.
